(19) United States
(12) Patent Application Publication
(10) Pub. No.: US 2026/0338144 A1
(43) Pub. Date: Oct. 29, 2026

(54) EXHAUST GAS RECIRCULATION CIRCUIT

(71) Applicant: GM Global Technology Operations LLC, Detroit, MI (US)

(72) Inventors: Michael L. Kociba, Plymouth, MI (US); Charles E. Allen, III, Lake Orion, MI (US); Joseph J. Noonchester, New Hudson, MI (US)

(21) Appl. No.: 19/191,014

(22) Filed: Apr. 28, 2025

(51) Int. Cl. F02M 26/50; F02M 26/00; F02M 26/61

(52) U.S. Cl. CPC F02M 26/50; F02M 26/61; F02M 2026/001

(57) ABSTRACT

An engine for a vehicle includes an intake conduit adapted to route ambient air to an intake manifold of the engine, an exhaust conduit adapted to route exhaust gases from the engine, an exhaust gas recirculation (EGR) circuit interconnecting the exhaust conduit to the intake manifold and adapted to selectively allow exhaust gas from the exhaust conduit to flow into the intake manifold wherein such exhaust gas mixes with ambient air from the intake conduit, and a fresh air bypass interconnecting the intake conduit and the EGR circuit and adapted to selectively allow ambient air from the intake conduit to flow into the EGR circuit.

### INTRODUCTION

The present disclosure relates to a method of controlling the accumulation of contamination within the exhaust gas recirculation circuit of an engine within a vehicle

Re-circulated exhaust gas (“EGR”) is utilized in internal combustion engines to assist in the reduction of throttling losses at low loads, to improve knock tolerance, and to reduce the level of oxides of nitrogen (“NOx”) in the exhaust gas. EGR is especially important as an emissions reducer in internal combustion engines that run lean of stoichiometry and are thus prone to emitting higher levels of NOx emissions. In current EGR circuits, water condensation and coking of exhaust system byproducts cause accumulation of contamination within the exhaust gas recirculation circuit.

Thus, while current EGR circuits achieve their intended purpose, there is a need for a new and improved system that includes a fresh air bypass adapted to flush the EGR circuit with fresh air to remove such contamination.

### SUMMARY

According to several aspects of the present disclosure, an engine for a vehicle includes an intake conduit adapted to route ambient air to an intake manifold of the engine, an exhaust conduit adapted to route exhaust gases from the engine, an exhaust gas recirculation (EGR) circuit interconnecting the exhaust conduit to the intake manifold and adapted to selectively allow exhaust gas from the exhaust conduit to flow into the intake manifold wherein such exhaust gas mixes with ambient air from the intake conduit, and a fresh air bypass interconnecting the intake conduit and the EGR circuit and adapted to selectively allow ambient air from the intake conduit to flow into the EGR circuit.

According to another aspect, the EGR circuit includes an exhaust gas control valve, moveable between an open state and a closed state, wherein, when in the open state, the EGR circuit is active and the exhaust gas control valve is adapted to allow exhaust gas to flow through the EGR circuit, and when in the closed state, the EGR circuit is in-active and the exhaust gas control valve is adapted to prevent exhaust gas from flowing through the EGR circuit, and, the fresh air bypass connects to the EGR circuit between the exhaust gas control valve and the intake manifold.

According to another aspect, the fresh air bypass includes a bypass valve, moveable between an open state and a closed state, wherein, when in the open state, the bypass valve is adapted to allow ambient air from the intake conduit to flow through the fresh air bypass and into the EGR circuit, and when in the closed state, the bypass valve is adapted to prevent ambient air from flowing from the intake conduit, through the fresh air bypass and into the EGR circuit.

According to another aspect, when the exhaust gas control valve is in the closed state and the EGR circuit is in-active, the bypass valve is adapted to allow ambient air from the intake conduit to flow through the fresh air bypass and into the EGR circuit, wherein the ambient air flows through the EGR circuit to the intake manifold and flushes existing contamination within the intake manifold through the engine, and prevents new contamination from accumulating within the intake manifold.

According to another aspect, the bypass valve is a passive one-way valve, wherein, when the EGR circuit is active, pressure of the exhaust gas flowing through the EGR circuit keeps the bypass valve closed, and when the EGR circuit is in-active, there is no pressure within the EGR circuit, and the bypass valve opens to allow ambient air from the intake conduit to flow through the fresh air bypass and into the EGR circuit.

According to another aspect, the bypass valve is an active valve adapted to be selectively moved between the open state, the closed state and any position therebetween, allowing a measured flow of ambient air from the intake conduit to flow through the fresh air bypass and into the EGR circuit.

According to another aspect, the bypass valve is one of a solenoid valve, ball valve, gate valve, globe valve, butterfly valve, plug valve, pinch valve, diaphragm valve, control valve, piston valve, poppet valve, rotary valve, slide valve or check valve that is actuated electronically, pneumatically, hydraulically or manually.

According to another aspect, when the exhaust gas control valve is open and the EGR circuit is active, the bypass valve is adapted to allow a measured flow of ambient air from the intake conduit to flow through the fresh air bypass and into the EGR circuit, wherein the ambient air dilutes the exhaust gas flowing through the EGR circuit to the intake manifold.

According to another aspect, the EGR circuit includes an exhaust gas cooler positioned between the exhaust conduit and the exhaust gas control valve.

According to another aspect, the exhaust gas control valve and the bypass valve are in communication with a controller within the vehicle, the controller adapted to selectively move the exhaust gas control valve and the bypass valve between the open state and the closed state.

According to several aspects of the present disclosure, a method of flushing contaminants from an intake manifold of an engine for a vehicle, includes routing, with an intake conduit, ambient air to an intake manifold of the engine, routing, with an exhaust conduit, exhaust gas from the engine, interconnecting, with an exhaust gas recirculation (EGR) circuit, the exhaust conduit to the intake manifold, selectively allowing exhaust gas from the exhaust conduit to flow into the intake manifold wherein such exhaust gas mixes with ambient air from the intake conduit, interconnecting, with a fresh air bypass, the intake conduit and the EGR circuit, and selectively allowing ambient air from the intake conduit to flow into the EGR circuit.

According to several aspects of the present disclosure, a vehicle according to an exemplary embodiment of the present disclosure includes an engine, an intake conduit adapted to route ambient air to an intake manifold of the engine, an exhaust conduit adapted to route exhaust gases from the engine, an exhaust gas recirculation (EGR) circuit interconnecting the exhaust conduit to the intake manifold and including an exhaust gas control valve, moveable between an open state and a closed state, wherein, when in the open state, the EGR circuit is active and the exhaust gas control valve is adapted to allow exhaust gas to flow through the EGR circuit and into the intake manifold wherein such exhaust gas mixes with ambient air from the intake conduit, and when in the closed state, the EGR circuit is in-active and the exhaust gas control valve is adapted to prevent exhaust gas from flowing through the EGR circuit, and a fresh air bypass interconnecting the intake conduit and the EGR circuit and including a bypass valve, moveable between and open state and a closed state, wherein, when in the open state, the bypass valve is adapted to allow ambient air from the intake conduit to flow through the fresh air bypass and into the EGR circuit, and when in the closed state, the bypass valve is adapted to prevent ambient air from flowing from the intake conduit, through the fresh air bypass and into the EGR circuit.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a vehicle with an internal combustion engine equipped with an exhaust gas recirculation circuit in accordance with an exemplary embodiment of the present disclosure;

FIG. 2 is a schematic diagram of the internal combustion engine and the exhaust gas recirculation circuit of the vehicle shown in FIG. 1; and

FIG. 3 is a schematic flow chart illustrating a method according to an exemplary embodiment of the present disclosure.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5%, “about”, with reference to temperatures, comprises a variation of plus/minus five degrees, and “about”, with reference to distances, comprises plus/minus 10%. In addition, disclosure of ranges includes disclosure of all values and further divided ranges within the entire range, including endpoints and sub-ranges given for the ranges.

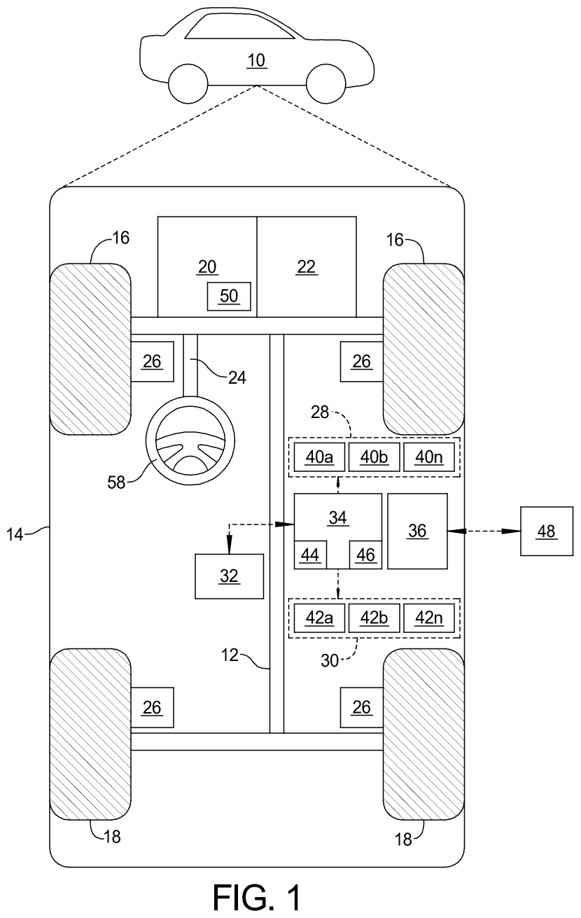

Example embodiments will now be described more fully with reference to the accompanying drawings. In accordance with an exemplary embodiment, FIG. 1 shows a vehicle 10 with an associated engine 50 in accordance with various embodiments. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The front wheels 16 and rear wheels 18 are each rotationally coupled to the chassis 12 near a respective corner of the body 14.

In various embodiments, the vehicle 10 is an autonomous vehicle and the system 11 is incorporated into the autonomous vehicle 10. An autonomous vehicle 10 is, for example, a vehicle 10 that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), etc., can also be used. The novel features of the present disclosure are applicable to both autonomous and non-autonomous vehicles.

As shown, the vehicle 10 generally includes a propulsion system 20, a transmission system 22, a steering system 24, a brake system 26, a sensor system 28, an actuator system 30, at least one data storage device 32, a vehicle controller 34, and a communication system 36. The propulsion system 20 may, in various embodiments, include an internal combustion engine 50. The transmission system 22 is configured to transmit power from the propulsion system 20 to the vehicle's front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the vehicle's front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. In an exemplary embodiment, the plurality of sensing devices 40a-40n includes at least one of a motor speed sensor, a motor torque sensor, an electric drive motor voltage and/or current sensor, an accelerator pedal position sensor, a coolant temperature sensor, a cooling fan speed sensor, a transmission oil temperature sensor, and sensors adapted to measure lateral and longitudinal acceleration. In another exemplary embodiment, the plurality of sensing devices 40a-40n further includes sensors to determine information about the environment surrounding the vehicle 10, for example, an ambient air temperature sensor, a barometric pressure sensor, and/or a photo and/or video camera which is positioned to view the environment in front of the vehicle 10. In another exemplary embodiment, at least one of the plurality of sensing devices 40a-40n is capable of measuring distances in the environment surrounding the vehicle 10. The actuator system 30 includes one or more actuator devices 42a-42n that control one or more vehicle 10 features such as, but not limited to, the propulsion system 20, the transmission system 22, the steering system 24, and the brake system 26.

The vehicle controller 34 includes at least one processor 44 and a computer-readable storage device or media 46. The at least one data processor 44 can be any custom made or commercially available processor, a central processing unit (CPU), a graphics processing unit (GPU), an auxiliary processor among several processors associated with the vehicle controller 34, a semi-conductor based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one data processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the at least one processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

The communication system 36 is configured to wirelessly communicate information to and from other remote entities 48, such as but not limited to, other vehicles (“V2V” communication,) infrastructure (“V2I” communication), remote systems, remote servers, cloud computers, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The vehicle controller 34 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

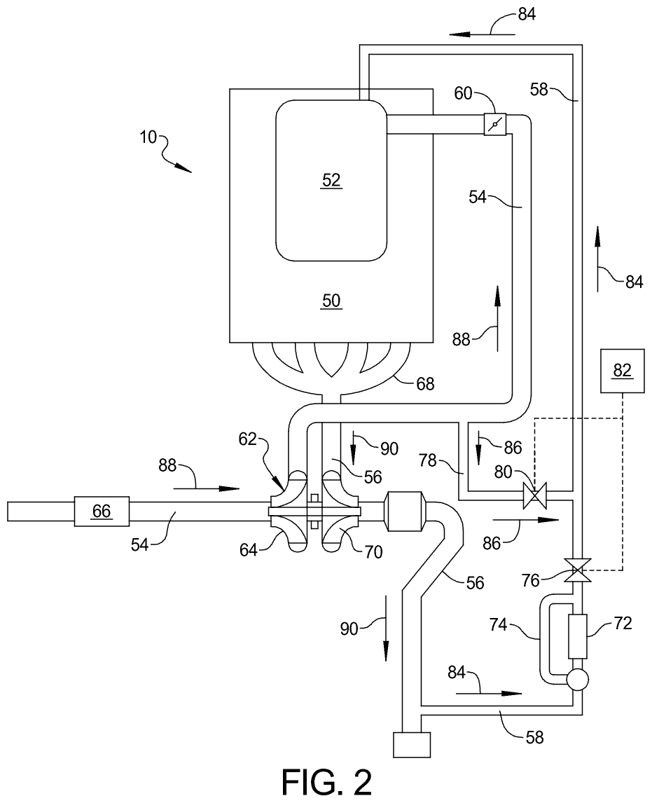

Referring to FIG. 2, in an exemplary embodiment, the engine 50 includes an intake manifold 52 and an intake conduit 54 adapted to route ambient air to the intake manifold 52, as indicated by arrows 88. An exhaust conduit 56 is adapted to route exhaust gases from the engine 50, as indicated by arrows 90. An exhaust gas recirculation (EGR) circuit 58 interconnects the exhaust conduit 56 to the intake manifold 52 and is adapted to selectively allow exhaust gas from the exhaust conduit 56 to flow into the intake manifold 52 wherein such exhaust gas mixes with ambient air from the intake conduit 54.

The intake manifold 52 is coupled to a cylinder head of the engine 50 and is in fluid communication with the intake conduit 54. A throttle body 60 is positioned within the intake conduit and may be configured for one or more purposes including: (a) airflow control, (b) smooth engine shutoff, and (c) control of a rate of flow of ambient air to the engine 50 through the intake manifold 52.

As shown, the engine 50 includes a turbocharger 62 including an intake side 64 (compressor) located in the intake conduit 54 and an air filter 66 located in the intake conduit 54. The intake conduit 54 defines an air inlet into the intake manifold 52, through the turbocharger 62. While a single turbocharger 62 is illustrated, it is understood that the present disclosure applies equally to arrangements including multiple turbochargers.

Additionally, it is understood that the present teachings apply to any number of piston-cylinder arrangements and a variety of reciprocating engine configurations including, but not limited to, V-engines, inline engines, and horizontally opposed engines, as well as both overhead cam and cam-in-block configurations.

The exhaust conduit 56 is connected to an exhaust manifold 66 mounted to the engine 50. An exhaust side 70 (turbine) of the turbocharger 62 is located in the exhaust conduit 56 and may include a turbine wheel in communication with and driven by exhaust gas flowing through the exhaust conduit 56. The exhaust side 70 of the turbocharger 62 may include a variable exhaust gas outlet that controls an exhaust gas flow restriction through the turbocharger 62.

In an exemplary embodiment, the EGR circuit 58 includes an exhaust gas control valve 76 that is moveable between an open state and a closed state. When the exhaust gas control valve 76 is in the open state, the EGR circuit 58 is active and the exhaust gas control valve 76 is adapted to allow exhaust gas to flow through the EGR circuit 58, as indicated by arrows 84. When the exhaust gas control valve is in the closed state, the EGR circuit 58 is in-active and the exhaust gas control valve 76 is adapted to prevent exhaust gas from flowing through the EGR circuit 58.

The engine 50 further includes a fresh air bypass 78 interconnecting the intake conduit 54 and the EGR circuit 58 and adapted to selectively allow ambient air from the intake conduit 54 to flow into the EGR circuit 58, as indicated by arrows 86. The fresh air bypass 78 connects to the EGR circuit 58 between the exhaust gas control valve 76 and the intake manifold 52.

In an exemplary embodiment, the fresh air bypass 78 includes a bypass valve 80, moveable between an open state and a closed state. When the bypass valve 80 is in the open state, the bypass valve 80 is adapted to allow ambient air from the intake conduit 54 to flow through the fresh air bypass 78 and into the EGR circuit 58. When in the closed state, the bypass valve 80 is adapted to prevent ambient air from flowing from the intake conduit 54, through the fresh air bypass 78 and into the EGR circuit 58.

A controller 82 is adapted to open and close the exhaust gas control valve 76 to make the EGR circuit 58 either active or in-active. The controller 82 may be the vehicle controller 34, or an engine controller or may be a separate controller in communication with the vehicle controller 34 and/or the engine controller.

During times when the EGR circuit 58 is active (exhaust gas is being re-circulated), moisture and contaminants from the exhaust gas cause condensation, and the presence of water, and coking within the intake manifold 52. Further, during times when the EGR circuit 58 is in-active (exhaust gas is not being re-circulated), leakage of exhaust gas across the exhaust gas control valve 76 allows further build-up of moisture and contamination within the intake manifold 52, If there is too much condensation and coking within the intake manifold 52, issues will arise, including, but not limited to, engine 50 mis-fires and non-compliance with emission requirements.

Thus, to prevent the levels of moisture and contamination within the intake manifold 52 from reaching levels that may cause negative side-effects, the controller 82 is adapted to use moments when the exhaust gas control valve 76 is in the closed state and the EGR circuit 58 is in-active, to actuate the bypass valve 80 to the open state, wherein ambient air from the intake conduit 54 is allowed to flow through the fresh air bypass 78 and into the EGR circuit 58, wherein the ambient air flows through the EGR circuit 58 to the intake manifold 52. Ambient air flowing through the intake manifold 52 from the EGR circuit 58 flushes existing moisture and contamination present within the intake manifold 52 through the engine 50. As long as the levels of moisture and contamination within the intake manifold 52 are not too high, there will be no negative effects and any moisture or contamination will move through the engine without incident. Therefore, the controller 82 will continuously look for any opportunity when the exhaust gas control valve 76 is in the closed state and the EGR circuit 58 is in-active to flush ambient air through the EGR circuit to the intake manifold 52.

Further, as long as ambient air is flowing through the intake manifold 52 from the EGR circuit 58, no additional moisture or contamination can accumulate, and, the flow of ambient air into the EGR circuit 58 eliminates the vacuum effect across the exhaust gas control valve 76 when the EGR circuit 58 is in-active, reducing the leakage of exhaust gas through the exhaust gas control valve 76, which reduces the amount of moisture and contamination that enters the EGR circuit 58. Therefore, the flow of ambient air through the EGR circuit 58 to the intake manifold 52, prevents new contamination from accumulating within the intake manifold.

In an exemplary embodiment, the bypass valve 80 is a passive one-way valve, such as a “flapper” valve. The passive bypass valve 80 operates passively, without communication with or direction from the controller 82. Rather, when the EGR circuit 58 is active, pressure of the exhaust gas flowing through the EGR circuit 58 keeps the bypass valve 80 closed, and when the EGR circuit 58 is in-active, there is no pressure (or at least very little pressure) within the EGR circuit 58, and the bypass valve 80 opens under pressure of the ambient air flowing within the intake conduit 54, to allow ambient air from the intake conduit 54 to flow through the fresh air bypass 78 and into the EGR circuit 58. Pressure of the exhaust gas within the EGR circuit 58 when the EGR circuit 58 is active is higher than pressure of the ambient air within the intake conduit 54, thus, if the EGR circuit 58 is active, and exhaust gas if flowing therethrough, the pressure therein will always keep the passive bypass valve 80 in the closed state.

In another exemplary embodiment, the bypass valve 80 is an active valve adapted to be selectively actuated, by the controller 82, between the open state (fully opened), the closed state (fully closed) and any position therebetween, allowing a measured flow of ambient air from the intake conduit 54 to flow through the fresh air bypass 78 and into the EGR circuit 58.

When the exhaust gas control valve 76 is in the closed state and the EGR circuit 58 is in-active, the controller 82 actuates the bypass valve 80 to the open state, wherein ambient air from the intake conduit 54 is allowed to flow through the fresh air bypass 78 and into the EGR circuit 58, wherein the ambient air flows through the EGR circuit 58 to the intake manifold 52 and flushes moisture and contamination through the engine 50.

Under certain circumstances it may be desirable, when the EGR circuit is active, to dilute the exhaust gas before it reaches the intake manifold 52. Thus, in an exemplary embodiment, when the exhaust gas control valve 76 is open and the EGR circuit 58 is active, the bypass valve 80 is adapted to allow a measured flow of ambient air from the intake conduit 54 to flow through the fresh air bypass 78 and into the EGR circuit 58, wherein the ambient air dilutes the exhaust gas flowing through the EGR circuit 58 to the intake manifold 52.

It should be understood by those skilled in the art that the exhaust gas control valve 76 and the bypass valve 80 may be any suitable valve for controlling flow of gas through a conduit. In exemplary embodiments, each of the bypass valve 80 and the exhaust gas control valve 76 are one of a solenoid valve, ball valve, gate valve, globe valve, butterfly valve, plug valve, pinch valve, diaphragm valve, control valve, piston valve, poppet valve, rotary valve, slide valve or check valve that is actuated, by the controller 82, electronically, pneumatically, hydraulically or manually.

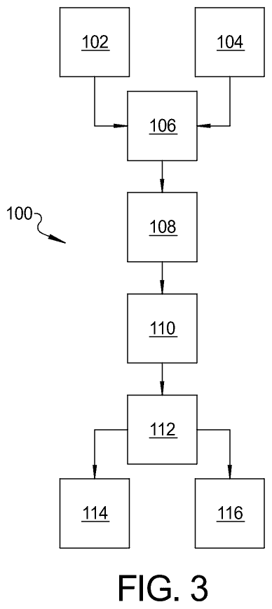

Referring to FIG. 3, a method 100 of flushing contaminants from an intake manifold 52 of an engine 50 for a vehicle 10 includes, beginning at block 102, routing, with an intake conduit 54, ambient air to an intake manifold 52 of the engine 50, and at block 104, routing, with an exhaust conduit 56, exhaust gas from the engine 50, moving from block 102 and block 104 to block 106, interconnecting, with an exhaust gas recirculation (EGR) circuit 58, the exhaust conduit 56 to the intake manifold 52, moving to block 108, selectively allowing exhaust gas from the exhaust conduit 56 to flow into the intake manifold 52 wherein such exhaust gas mixes with ambient air from the intake conduit 54, moving to block 110, interconnecting, with a fresh air bypass 78, the intake conduit 54 and the EGR circuit 58, and, moving to block 112, selectively allowing ambient air from the intake conduit 54 to flow into the EGR circuit 58.

In an exemplary embodiment, the selectively allowing exhaust gas from the exhaust conduit 56 to flow into the intake manifold 52 at block 108 further includes selectively moving an exhaust gas control valve 76 between an open state and a closed state, wherein, when in the open state, the EGR circuit 58 is active and the exhaust gas control valve 76 is adapted to allow exhaust gas to flow through the EGR circuit 58, and when in the closed state, the EGR circuit 58 is in-active and the exhaust gas control valve 76 is adapted to prevent exhaust gas from flowing through the EGR circuit 58, and, the interconnecting, with the fresh air bypass 78, the intake conduit 54 and the EGR circuit 58 at block 110 further includes, connecting the fresh air bypass 78 to the EGR circuit 58 between the exhaust gas control valve 76 and the intake manifold 52.

In another exemplary embodiment, the selectively allowing ambient air from the intake conduit 54 to flow into the EGR circuit 58 at block 112 further includes selectively moving a bypass valve 80 of the fresh air bypass 78 between an open state and a closed state, wherein, when in the open state, the bypass valve 80 is adapted to allow ambient air from the intake conduit 54 to flow through the fresh air bypass 78 and into the EGR circuit 58, and when in the closed state, the bypass valve 80 is adapted to prevent ambient air from flowing from the intake conduit 54, through the fresh air bypass 78 and into the EGR circuit 58.

In another exemplary embodiment, the method 100 further includes, when the exhaust gas control valve 76 is in the closed state and the EGR circuit 58 is in-active, moving from block 112 to block 114, moving the bypass valve 80 of the fresh air bypass 78 to the open state, allowing ambient air from the intake conduit 54 to flow through the fresh air bypass 78 and into the EGR circuit 58, and through the EGR circuit 58 to the intake manifold 52, and flushing existing contamination within the intake manifold 52 through the engine 50 and preventing new contamination from accumulating within the intake manifold 52.

In another exemplary embodiment, the selectively moving the bypass valve 80 of the fresh air bypass 78 between an open state and a closed state further includes selectively actuating, with a controller 82 in communication with the bypass valve 80, the bypass valve 80 between the open state, the closed state and any position therebetween, and allowing a measured flow of ambient air from the intake conduit 54 to flow through the fresh air bypass 78 and into the EGR circuit 58, wherein, the bypass valve 80 is one of a solenoid valve, ball valve, gate valve, globe valve, butterfly valve, plug valve, pinch valve, diaphragm valve, control valve, piston valve, poppet valve, rotary valve, slide valve or check valve that is actuated, by the controller 82, electronically, pneumatically, hydraulically or manually.

In another exemplary embodiment, the method 100 further includes, when the exhaust gas control valve 76 is open and the EGR circuit 58 is active, moving from block 112 to block 116, actuating, with the controller 82, the bypass valve 80 to the open state, allowing, with the bypass valve 80, a measured flow of ambient air from the intake conduit 54 to flow through the fresh air bypass 78 and into the EGR circuit 58, and diluting the exhaust gas flowing through the EGR circuit 58 to the intake manifold 54.

In another exemplary embodiment, the interconnecting, with the EGR circuit 58, the exhaust conduit 56 to the intake manifold 52 at block 106 further includes routing exhaust gas through an exhaust gas cooler 72 positioned between the exhaust conduit 56 and the exhaust gas control valve 76.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. An engine for a vehicle, comprising:
an intake conduit adapted to route ambient air to an intake manifold of the engine;
an exhaust conduit adapted to route exhaust gases from the engine;
an exhaust gas recirculation (EGR) circuit interconnecting the exhaust conduit directly to the intake manifold and adapted to selectively allow exhaust gas from the exhaust conduit to flow into the intake manifold wherein such exhaust gas mixes with ambient air from the intake conduit, wherein the EGR circuit does not pass through a compressor between the exhaust conduit and the intake manifold; and
a fresh air bypass interconnecting the intake conduit and the EGR circuit and adapted to selectively allow ambient air from the intake conduit to flow into the EGR circuit.

2. The engine of claim 1, wherein the EGR circuit includes an exhaust gas control valve, moveable between an open state and a closed state, wherein, when in the open state, the EGR circuit is active and the exhaust gas control valve is adapted to allow exhaust gas to flow through the EGR circuit, and when in the closed state, the EGR circuit is in-active and the exhaust gas control valve is adapted to prevent exhaust gas from flowing through the EGR circuit, and, the fresh air bypass connects to the EGR circuit between the exhaust gas control valve and the intake manifold.

3. The engine of claim 2, wherein the fresh air bypass includes a bypass valve, moveable between an open state and a closed state, wherein, when in the open state, the bypass valve is adapted to allow ambient air from the intake conduit to flow through the fresh air bypass and into the EGR circuit, and when in the closed state, the bypass valve is adapted to prevent ambient air from flowing from the intake conduit, through the fresh air bypass and into the EGR circuit.

4. The engine of claim 3, wherein, when the exhaust gas control valve is in the closed state and the EGR circuit is in-active, the bypass valve is adapted to allow ambient air from the intake conduit to flow through the fresh air bypass and into the EGR circuit, wherein the ambient air flows through the EGR circuit to the intake manifold and:
flushes existing contamination within the intake manifold through the engine; and
prevents new contamination from accumulating within the intake manifold.

5. The engine of claim 4, wherein the bypass valve is a passive one-way valve, wherein:
when the EGR circuit is active, pressure of the exhaust gas flowing through the EGR circuit keeps the bypass valve closed; and
when the EGR circuit is in-active, there is no pressure within the EGR circuit, and the bypass valve opens to allow ambient air from the intake conduit to flow through the fresh air bypass and into the EGR circuit.

6. The engine of claim 4, wherein the bypass valve is an active valve adapted to be selectively moved between the open state, the closed state and any position therebetween, allowing a measured flow of ambient air from the intake conduit to flow through the fresh air bypass and into the EGR circuit.

7. The engine of claim 6, wherein the bypass valve is one of a solenoid valve, ball valve, gate valve, globe valve, butterfly valve, plug valve, pinch valve, diaphragm valve, control valve, piston valve, poppet valve, rotary valve, slide valve or check valve that is actuated electronically, pneumatically, hydraulically or manually.

8. The engine of claim 6, wherein, when the exhaust gas control valve is open and the EGR circuit is active, the bypass valve is adapted to allow a measured flow of ambient air from the intake conduit to flow through the fresh air bypass and into the EGR circuit, wherein the ambient air dilutes the exhaust gas flowing through the EGR circuit to the intake manifold.

9. The engine of claim 8, wherein the EGR circuit includes an exhaust gas cooler positioned between the exhaust conduit and the exhaust gas control valve.

10. The engine of claim 9, wherein the exhaust gas control valve and the bypass valve are in communication with a controller within the vehicle, the controller adapted to selectively move the exhaust gas control valve and the bypass valve between the open state and the closed state.

11. A method of flushing contaminants from an intake manifold of an engine for a vehicle, comprising:
routing, with an intake conduit, ambient air to an intake manifold of the engine;
routing, with an exhaust conduit, exhaust gas from the engine;
interconnecting, with an exhaust gas recirculation (EGR) circuit, the exhaust conduit directly to the intake manifold;
selectively allowing exhaust gas from the exhaust conduit to flow into the intake manifold wherein such exhaust gas mixes with ambient air from the intake conduit, wherein the EGR circuit does not pass through a compressor between the exhaust conduit and the intake manifold;
interconnecting, with a fresh air bypass, the intake conduit and the EGR circuit; and
selectively allowing ambient air from the intake conduit to flow into the EGR circuit.

12. The method of claim 11, wherein the selectively allowing exhaust gas from the exhaust conduit to flow into the intake manifold further includes selectively moving an exhaust gas control valve between an open state and a closed state, wherein, when in the open state, the EGR circuit is active and the exhaust gas control valve is adapted to allow exhaust gas to flow through the EGR circuit, and when in the closed state, the EGR circuit is in-active and the exhaust gas control valve is adapted to prevent exhaust gas from flowing through the EGR circuit; and
the interconnecting, with the fresh air bypass, the intake conduit and the EGR circuit further includes, connecting the fresh air bypass to the EGR circuit between the exhaust gas control valve and the intake manifold.

13. The method of claim 12, wherein the selectively allowing ambient air from the intake conduit to flow into the EGR circuit further includes selectively moving a bypass valve of the fresh air bypass between an open state and a closed state, wherein, when in the open state, the bypass valve is adapted to allow ambient air from the intake conduit to flow through the fresh air bypass and into the EGR circuit, and when in the closed state, the bypass valve is adapted to prevent ambient air from flowing from the intake conduit, through the fresh air bypass and into the EGR circuit.

14. The method of claim 13, further including, when the exhaust gas control valve is in the closed state and the EGR circuit is in-active:
moving the bypass valve of the fresh air bypass to the open state;
allowing ambient air from the intake conduit to flow through the fresh air bypass and into the EGR circuit, and through the EGR circuit to the intake manifold;
flushing existing contamination within the intake manifold through the engine; and
preventing new contamination from accumulating within the intake manifold.

15. The method of claim 14, wherein the selectively moving the bypass valve of the fresh air bypass between an open state and a closed state further includes selectively actuating, with a controller in communication with the bypass valve, the bypass valve between the open state, the closed state and any position therebetween, and allowing a measured flow of ambient air from the intake conduit to flow through the fresh air bypass and into the EGR circuit, wherein, the bypass valve is one of a solenoid valve, ball valve, gate valve, globe valve, butterfly valve, plug valve, pinch valve, diaphragm valve, control valve, piston valve, poppet valve, rotary valve, slide valve or check valve that is actuated, by the controller, electronically, pneumatically, hydraulically or manually.

16. The method of claim 15, further including, when the exhaust gas control valve is open and the EGR circuit is active:
actuating, with the controller, the bypass valve to the open state;
allowing, with the bypass valve, a measured flow of ambient air from the intake conduit to flow through the fresh air bypass and into the EGR circuit; and
diluting the exhaust gas flowing through the EGR circuit to the intake manifold.

17. The method of claim 16, wherein the interconnecting, with the EGR circuit, the exhaust conduit to the intake manifold further includes routing exhaust gas through an exhaust gas cooler positioned between the exhaust conduit and the exhaust gas control valve.

18. A vehicle, comprising:
an engine;
an intake conduit adapted to route ambient air to an intake manifold of the engine;
an exhaust conduit adapted to route exhaust gases from the engine;
an exhaust gas recirculation (EGR) circuit interconnecting the exhaust conduit directly to the intake manifold and including an exhaust gas control valve, moveable between an open state and a closed state, wherein:
when in the open state, the EGR circuit is active and the exhaust gas control valve is adapted to allow exhaust gas to flow through the EGR circuit and into the intake manifold wherein such exhaust gas mixes with ambient air from the intake conduit, wherein the EGR circuit does not pass through a compressor between the exhaust conduit and the intake manifold; and
when in the closed state, the EGR circuit is in-active and the exhaust gas control valve is adapted to prevent exhaust gas from flowing through the EGR circuit; and
a fresh air bypass interconnecting the intake conduit and the EGR circuit and including a bypass valve, moveable between and open state and a closed state, wherein:
when in the open state, the bypass valve is adapted to allow ambient air from the intake conduit to flow through the fresh air bypass and into the EGR circuit; and
when in the closed state, the bypass valve is adapted to prevent ambient air from flowing from the intake conduit, through the fresh air bypass and into the EGR circuit.

19. The vehicle of claim 18, wherein, the bypass valve is a passive one-way valve, wherein:
when the EGR circuit is active, pressure of the exhaust gas flowing through the EGR circuit keeps the bypass valve closed; and
when the exhaust gas control valve is in the closed state and the EGR circuit is in-active, there is no pressure within the EGR circuit, and the bypass valve opens to allow ambient air from the intake conduit to flow through the fresh air bypass, into the EGR circuit, wherein the ambient air flows through the EGR circuit to the intake manifold, flushes existing contamination within the intake manifold through the engine, and prevents new contamination from accumulating within the intake manifold.

20. The vehicle of claim 19, wherein:
the bypass valve is an active valve adapted to be selectively moved, by a controller in communication therewith, between the open state, the closed state and any position therebetween, allowing a measured flow of ambient air from the intake conduit to flow through the fresh air bypass and into the EGR circuit;
the bypass valve is one of a solenoid valve, ball valve, gate valve, globe valve, butterfly valve, plug valve, pinch valve, diaphragm valve, control valve, piston valve, poppet valve, rotary valve, slide valve or check valve that is actuated electronically, pneumatically, hydraulically or manually; and
when the exhaust gas control valve is open and the EGR circuit is active, the bypass valve is adapted to allow a measured flow of ambient air from the intake conduit to flow through the fresh air bypass and into the EGR circuit, wherein the ambient air dilutes the exhaust gas flowing through the EGR circuit to the intake manifold.
